(19) United States
(12) Patent Application Publication
(10) Pub. No.: US 2015/0007337 A1
(43) Pub. Date: Jan. 1, 2015

(54) Solid State Drive Physical Uncloneable Function Erase Verification Device and Method

(71) Applicant: Christian Krutzik, Costa Mesa, CA (US)

(72) Inventor: Christian Krutzik, Costa Mesa, CA (US)

(21) Appl. No.: 14/320,112

(22) Filed: Jun. 30, 2014

Related U.S. Application Data
(60) Provisional application No. 61/841,453, filed on Jul. 1, 2013.

(51) Int. Cl. G06F 12/14; G06F 21/73

(52) U.S. Cl. CPC G06F 12/14; G06F 21/73
USPC 726/26

(57) ABSTRACT

A method is provided to verify that a memory device has been erased and that the device is the originally intended item. Physically uncloneable features of the memory are revealed after erase and form the data for a fingerprint that verifies that the memory has not been exchanged for another memory. A PUF inherent in multiple memory devices included in the memory is revealed upon erase and the PUF is used to create and ID. This ID is compared to the ID for the original unit.

### CROSS-REFERENCE TO RELATED APPLICATIONS

This application claims the benefit of U.S. Provisional Patent Application No. 61/841,453 filed on Jul. 1, 2013 entitled “Solid State Drive Physical Uncloneable Function Erase Verification Device and Method” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of solid state memory devices. More specifically, the invention relates to a physical uncloneable function used to verify erasure of the contents of a flash memory device including confidence that the erased device is the same device that was expected to have been erased.

2. Description of the Prior Art

It is known that data stored in flash memory such as NAND flash memory can later be recovered by an unauthorized user in the form of “remnant data” even after data is deleted by the authorized user. Therefore, commercial and government users of solid state drives (“SSD”) have a need to “sanitize”, i.e., render unrecoverable, data such as cryptographic keys stored in flash memory cells.

In general, physical uncloneable function or “PUF” electronic devices are easy to implement but difficult to duplicate and rely on random and specific physical characteristics of a device to create a random, stable identifier or “fingerprint” of that device.

The first such devices were film-based devices introduced by Pappu et al. in 2002. They used laser light scattered off bubble-filled transparent epoxy films to generate random interference patterns.

Since then, silicon PUFs (SPUFs) have been introduced that take advantage of slight, random differences in signal delays of internal signal lines which are designed using symmetrical path race conditions, or that take advantage of the doping or other mismatch between gates in memory structures, such as SRAM cells, cross-coupled NOR gates or cross-coupled latches or butterfly circuits. These slight variations arise from random, uncontrollable variations in semiconductor processes used in the fabrication of the integrated circuit and vary from device-to-device; resulting in a unique device fingerprint identifier for each.

What is needed is a device and method that takes advantage of a physical uncloneable function that provides the user with the assurance that an erase command has rendered all data in the device unrecoverable and that a substitute device has not been exchanged for the original item.

### BRIEF SUMMARY OF THE INVENTION

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

The verification of a sanitizing erase operation disclosed herein desirably addresses all NAND flash cells in a device, including any bad blocks, spare areas, overprovisioning, reserved/hidden partitions, and the like.

Assurance that an alternate device has not been surreptitiously substituted is ascertained by physically uncloneable features that form a fingerprint of the device and are revealed after full erasure. These features are random defects such as Bad blocks (grown blocks will also occur but initial bad blocks will always remain, bad blocks also have unique “signatures” in failing method); Stuck bits; Read errors; program/read disturbances, neighboring cell susceptibilities. Voltage margining, timing, can be used to reveal these defects.

### BRIEF DESCRIPTION OF THE SEVERAL VIEWS OF THE DRAWINGS

FIG. 1 depicts the method and devices by which a memory device is erased and is verified and that the device is the originally intended item

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

Turning now to the figures wherein like numerals define like elements among the several views, a physically uncloneable function (“PUF”) challenge and respond circuit and module to provide secure private encryption key generation and storage having one or more tamper-resistant circuit functions is disclosed.

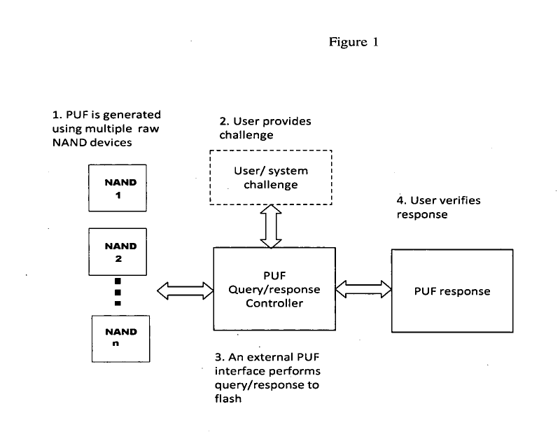

Turning now to FIG. 1 wherein like references define like elements, Applicant discloses a solid state drive (“SSD”) physical uncloneable (“PUF”) verification device and method for secure erasure of data in an SSD and verification of device authenticity.

A problem exists in SSD flash memory devices as to verification that data on an SSD or mobile tablet (i.e. any hardware with NAND flash) is actually erased at the raw cell level along with a related problem as to how to verify NAND flash devices are restored to an original “factory” condition and the device erased is not one substituted.

The invention herein address the above deficiencies in prior art SSD data erase verification devices and methods and uses a PUF based on NAND flash bit error/read disturb variations inherent in flash memory devices.

The PUF of the invention is used to provide the user with a challenge response in order to verify an erase has occurred and may be configured to be used remotely by providing a challenge response to an inquiring party. A user challenge may be any request from the PUF system for information or system characteristic that is known to the user much as in the form or a password or authentication request in an information system.

The PUF herein is generated by bit error/read disturb/program variations inherently present in flash memory. Read retry and forced threshold variations may be also be incorporated into the PUF.

The PUF uses a combination of bit errors across all cells (achievable by a first pass erase of the flash cells) and then a function of certain NAND flash areas based on challenges used to further calculate a PUF based on additional predetermined physical characteristics of the flash such as read disturb that may require data patterns to be read/written to one or more cells. Because performing such operations on the entire set of flash cells in a large memory array would be time consuming, the operations may be selectively targeted to look to unique sets of cells such as a predetermined bank of each flash die. This is particularly beneficial considering a typical SSD may have 4-8 flash memory packages with eight memory die in each, i.e., 32-64 flash die.

The disclosed method is useful in a cloud or remote environment, for example, for use by a manufacturer to verify that a user has completely erased an SSD. It is also useful when freshly installing an SSD drive, if one wants to verify that SSD is clean and in factory condition. It can also be used to verify that the NAND flash devices installed on an SSD are original factory parts or in mobile devices to verify the flash is erased.

To ensure full erasure of an SSD, the PUF based on NAND-flash characteristics need only return a correct response by erasing the drive since that is how the PUF is calculated. The PUF may be spread across all die in the SSD.

A user controls the challenge to avoid any replay attacks which can also be controlled in SSD with a simple look up table as can be done securely with a COTS secure EEPROM.

The PUF of the invention may utilize various NAND flash “randomness” characteristics including but not limited to the unique, physical uncloneable flash characteristics below:
1. Bad blocks (grown blocks will also occur but initial bad blocks will always remain, bad blocks also have unique “signatures” in failing method),
2. Voltage margining,
3. Timing,
4. Stuck bits,
5. Read errors,
6. Program/read disturb.

It is known that MLC flash is sensitive to process variations in threshold voltages, especially as device geometries are shrinking (since voltage margin is reduced). MLC is also susceptible to program variations of neighboring cells. This flash characteristic may be utilized as a PUF herein by writing specific patterns into flash and then reading out and checking bit errors.

As threshold levels are disturbed due to program/erase cycles, charge loss over time, etc., there may be issues with stability for certain types of PUF queries which should be considered.

To solve this potential issue, a small portion of each flash die may be saved and dedicated for PUF calculation and use and would intentionally be limited to a low number of PE cycles.

Also, using “read retry” flash commands, threshold levels may be adjusted such that the PUF can be generated based on relative threshold variations between flash cells (across blocks or die).

Similarly, the read retry may be used to adjust threshold levels and the resulting response be part of the PUF (i.e. lower the threshold 5% and monitor which bits are read as a new state).

The PUF approach of the method of the invention using PUF calculated from NAND flash to fully verify the drive is erased may also be used to verify the integrity of the flash (i.e. is it factory original) and used in a remote (e.g. cloud) environment; e.g., a user can remotely query the drive after performing the erase, i.e., the drive will only return a correct response by erasing the drive in order to calculate the PUF. The key is to use the flash such that the only method to calculate the PUF is to erase the flash (e.g. erase flash to all 1's and see which bits are stuck 0).

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the fact that the elements of such a claim may be set forth in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a subcombination or variation of a subcombination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

We claim:

1. A method of revealing a set of randomly occurring residual features of memory devices by erasing all erasable bits of memory.

2. A method for utilizing the random residual features of claim 1 to generate a Physically Uncloneable Function that serves as a fingerprint of the device and can be compared to the initially installed device.

3. A method of claim 2 utilizing Stuck Bits.

4. A method of claim 2 utilizing Read Errors

5. A method of claim 2 utilizing Program/Read disturb defects

6. A method of claim 2 utilizing other random stable defects

7. A method of claim 2 utilizing Bad Block list

8. A method of claim 2 utilizing using voltage margining to accentuate the defects of claims 3 through 7

9. A method of claim 2 utilizing using timing to accentuate the defects of claims 3 through 7

10. A method of claim 2 utilizing using read retry to adjust threshold levels to accentuate the defects of claims 3 through 7

11. A method of claim 2 utilizing using other means to accentuate the defects of claims 3 through 7

12. A method of claim 1 wherein the random features used for claim 2 are contained in partitioned areas protected from frequent use so as to prevent degradations of PUF stability.

13. A method of claims 1-11 to verify memory remotely
